(19) United States
(12) Patent Application Publication
(10) Pub. No.: US 2015/0375379 A1
(43) Pub. Date: Dec. 31, 2015

(54) TORQUE WRENCH HAVING TRANSPARENT WINDOW ILLUMINATION STRUCTURE

(71) Applicant: TORQUE-TECH PRECISION CO., LTD., Taichung (TW)

(72) Inventor: Tien-Lung LIN, Taichung (TW)

(21) Appl. No.: 14/314,499

(22) Filed: Jun. 25, 2014

(51) Int. Cl. B25B 23/142; F21V 33/00

(52) U.S. Cl. CPC B25B 23/1422; F21V 33/0084

(57) ABSTRACT

A torque wrench having a transparent window illumination structure includes a torque wrench main body. The outer surface of the torque wrench main body has at least one window. A torque indicator is provided corresponding in position to the window. An illuminating member is disposed at an end of the torque indicator opposite to the window.

The illuminating member is electrically connected with a control unit. When the illuminating member illuminates, the light from the illuminating member will first pass through the indication portion and then the window. Under an inadequate lighting environment, through the window, the user can watch the indication portion clearly to know the present setting torque value of the torque wrench.

### BACKGROUND OF THE INVENTION

1. Field of the Invention

The present invention relates to a torque wrench, and more particularly to a torque wrench having a transparent window illumination structure.

2. Description of the Prior Art

A conventional mechanical torque wrench has a torque wrench main body. The torque wrench main body is provided with a torque value adjustment mechanism for adjusting the output torque value of the torque wrench. For the user to know the present setting torque value of the torque wrench exactly, the outer surface of the torque wrench has a window. The window has an indication portion therein, such as a scale indicator or a numerical wheel set, for the user to watch the indication portion directly through the window.

When the torque wrench main body is operated under an inadequate lighting environment, the user cannot watch the indication portion clearly. Therefore, the user has to use a flashlight to illuminate the window for the user to watch the indication portion. It is inconvenient for operation. A digital torque wrench is provided with an LCD screen instead of the window to overcome the aforesaid shortcoming. However, the cost of the digital torque wrench is high and the structure is complicated. When the torque wrench has a collision, its electronic parts may be damaged with ease. The digital torque wrench is not durable. Accordingly, the inventor of the present invention has devoted himself based on his many years of practical experiences to solve these problems.

### SUMMARY OF THE INVENTION

The primary object of the present invention is to provide a torque wrench having a transparent window illumination structure. Under an inadequate lighting environment, the present invention provides an illumination effect to assist the user in knowing the present setting torque value of the torque wrench.

In order to achieve the aforesaid objects, the torque wrench having a transparent window illumination structure of the present invention comprises a torque wrench main body, a torque indicator, at least one illuminating member, and a control unit. The torque wrench main body has at least one window on an outer surface thereon. The torque indicator corresponds in position to the window. The torque indicator has an indication portion which is pervious to light. The indication portion is adapted to show the present setting torque value of the torque wrench main body. The illuminating member is disposed at an end of the torque indicator opposite to the window. The light from the illuminating member first passes through the indication portion and then the window. The control unit is disposed on the torque wrench main body and electrically connected with the illuminating member. The control unit has a switch member adapted to turn on/off the illuminating member and at least one battery for supplying power.

When the user turns on the switch member to drive the illuminating member to illuminate, because the illuminating member is disposed at the end of the torque indicator opposite to the window, the light from the illuminating member will first pass through the indication portion and then the window to provide illumination to the indication portion. When the present invention is used under an inadequate lighting environment, through the window, the user can watch the indication portion clearly to know the present setting torque value of the torque wrench main body, without using a flashlight. The present invention enhances the convenience of operation greatly.

### BRIEF DESCRIPTION OF THE DRAWINGS

FIG. 1 is a perspective view according to a first embodiment of the present invention;

FIG. 2 is a partial exploded view according to the first embodiment of the present invention;

FIG. 3 is another partial exploded view according to the first embodiment of the present invention;

FIG. 4 is a sectional view according to the first embodiment of the present invention;

FIG. 5 is a plan view showing the torque indicator according to the first embodiment of the present invention;

FIG. 6 is a schematic view according to the first embodiment of the present invention when in use; and

FIG. 7 is a partial exploded view according to a second embodiment of the present invention.

### DETAILED DESCRIPTION OF THE PREFERRED EMBODIMENTS

Embodiments of the present invention will now be described, by way of example only, with reference to the accompanying drawings.

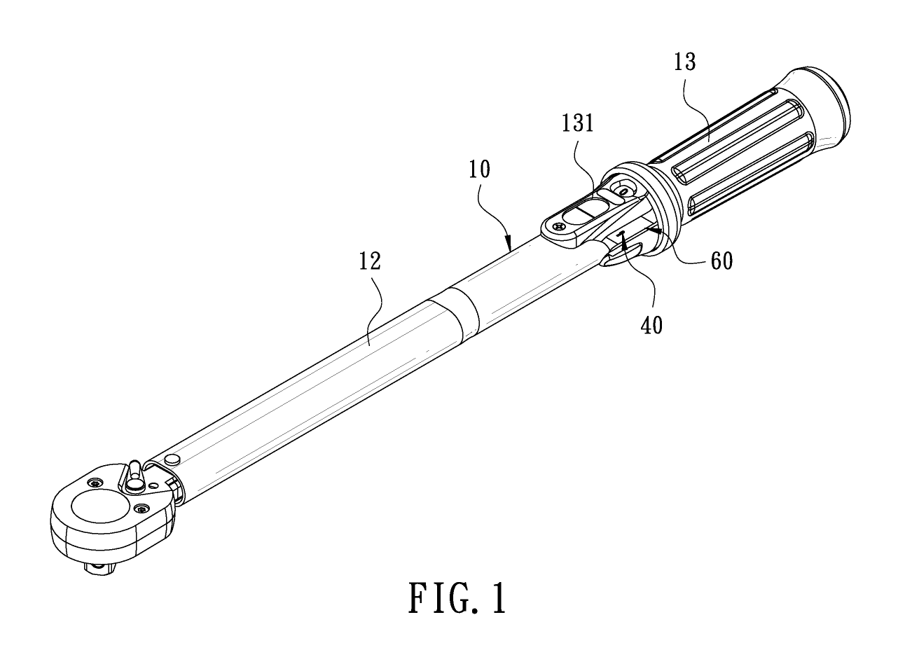

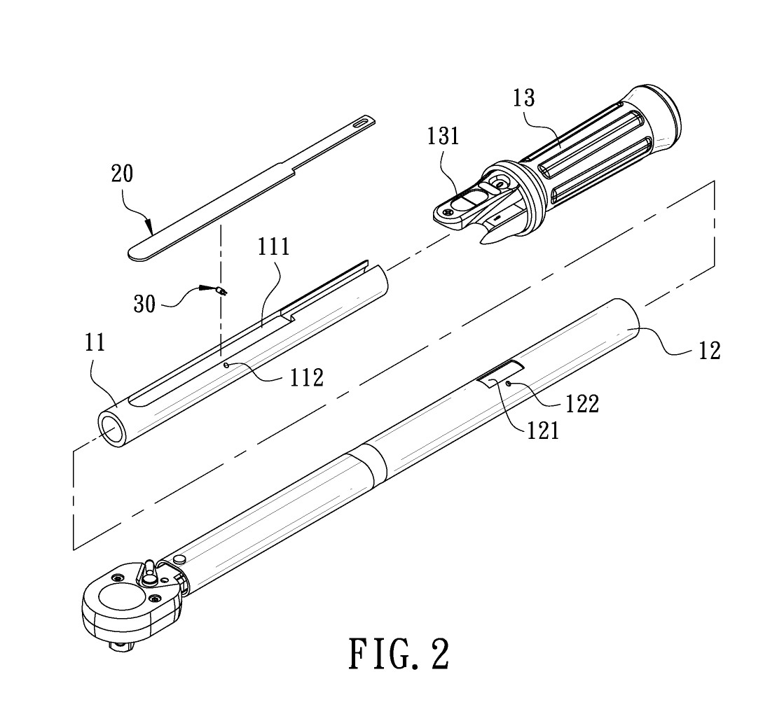

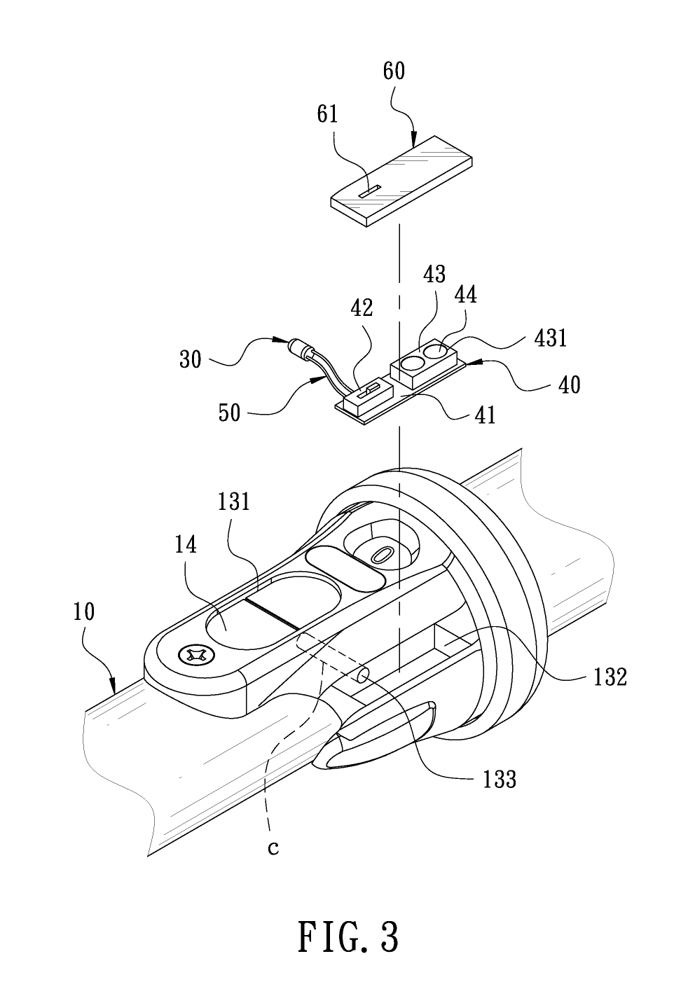

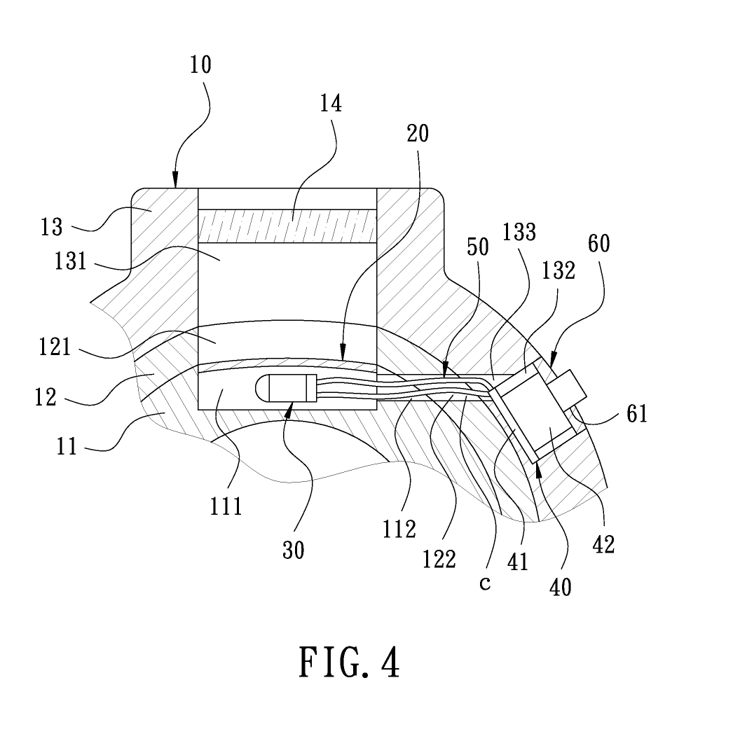

FIG. 1 is a perspective view according to a first embodiment of the present invention. FIG. 2 is a partial exploded view according to the first embodiment of the present invention. FIG. 3 is another partial exploded view according to the first embodiment of the present invention. FIG. 4 is a sectional view according to the first embodiment of the present invention. The present invention discloses a torque wrench having a transparent window illumination structure. The torque wrench having a transparent window illumination structure comprises a torque wrench main body 10, a torque indicator 20, at least one illuminating member 30, and a control unit 40.

The torque wrench main body 10, as shown in FIG. 2, has an inner rod 11, an outer rod 12, and a handle 13. The inner rod 11 has a groove 111 on an outer surface thereof and a first through hole 112 communicating with the groove 111. The outer rod 12 is fitted at an outer end of the inner rod 11. The outer rod 12 has an opening 121 corresponding to the groove 111 and a second through hole 122 corresponding to the first through hole 112. The handle 13 is fitted at an outer end of the outer rod 12. The handle 13 has at least one window 131 on an outer surface thereof. The window 131 corresponds in position to the opening 121. In this embodiment, as shown in FIG. 4, the outer surface of the handle 13 has one window 131. The window 13 is covered with a transparent positioning plate 14. The handle 13 further has an accommodation trough 132 thereon and a third through hole 133 corresponding to the second through hole 122. The third through hole 133 communicates with the accommodation trough 132, such that the first through hole 112, the second through hole 122, and the third through hole 133 constitutes a passage C communicating with the groove 111 and the accommodation through 132.

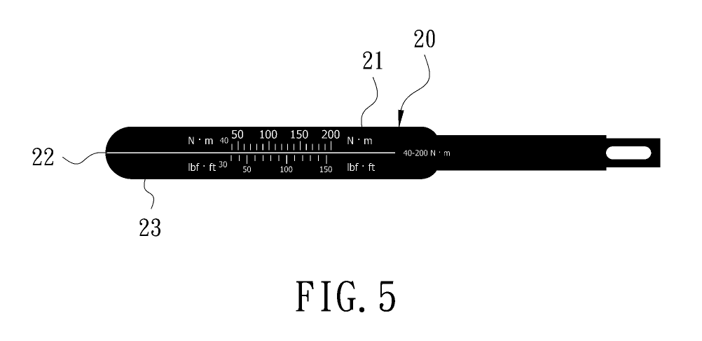

The torque indicator 20 corresponds in position to the window 131. In this embodiment, the torque indicator 20 is disposed in the groove 111. As shown in FIG. 5, the torque indicator 20 has a transparent body 21. The transparent body 21 has an indication portion 22 thereon. The indication portion 22 is adapted to show the present setting torque value of the torque wrench main body 10. The rest of the transparent body 21, except the indication portion 22, is an opaque portion 23, so only the indication portion 22 of the transparent body 21 is pervious to light. The indication portion 22 is a scale mark. The opaque portion 23 is a black coating.

The illuminating member 30 is disposed at an end of the torque indicator 20 opposite to the window 131. The light from the illuminating member 30 first passes through the indication portion 22 and then the window 131. This embodiment has one illuminating member 30. The illuminating member 30 is a light emitting diode disposed in the groove 111. As shown in FIG. 4, the illuminating member 30 is disposed under the torque indicator 20.

The control unit 40 is disposed on the torque wrench main body 10. In this embodiment, as shown in FIG. 3, the control unit 40 is disposed in the accommodation trough 132. The control unit 40 has a circuit board 41, a switch member 42, a battery case 43, and at least one battery 44. The switch member 42 is adapted to turn on/off the illuminating member 30. In this embodiment, the switch member 42 is a DIP switch disposed on the circuit board 41. The battery case 43 is also disposed on the circuit board 41. The battery case 43 has at least one battery trough 431. The battery 44 is adapted to supply power and disposed in the battery trough 431 and assembled on the circuit board 41, such that the switch member 42 and the battery 44 are electrically connected through the circuit board 41.

The present invention further comprises a plurality of electric wires 50. The electric wires 50 are inserted in the passage C composed of the first through hole 112, the second through hole 122 and the third through hole 133, and connected between the illuminating member 30 and the control unit 40 for electrically connecting the illuminating member 30 and the control unit 40. In this embodiment, one end of each electric wire 50 is directly connected to the illuminating member 30 and another end of each electric wire 50 is connected to the circuit board 41, so that the illuminating member 30 and the control unit 40 are electrically connected.

The present invention further comprises an outer lid 60. The outer lid 60 is adapted to cover the accommodation trough 132, and has a through hole 61 for the knob of the switch member 42 to pass therethrough.

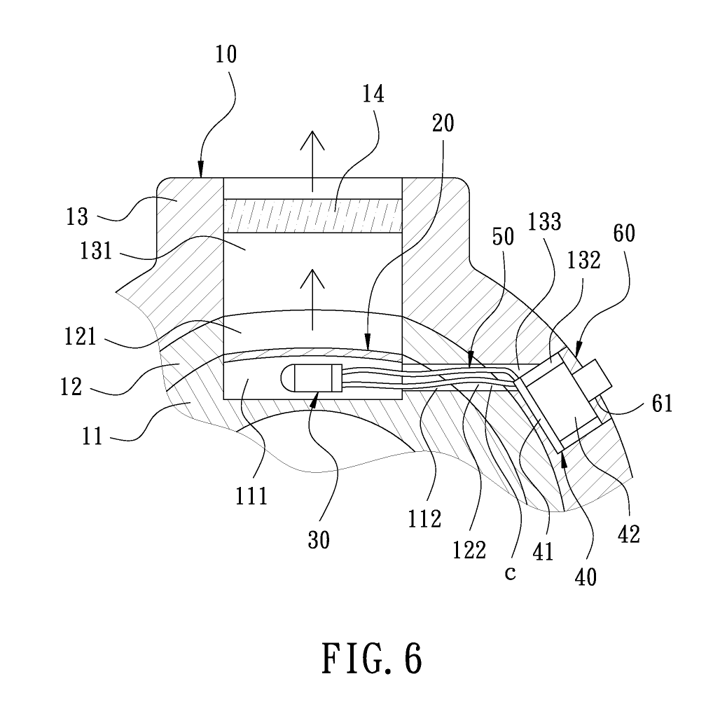

FIG. 6 is a schematic view according to the first embodiment of the present invention when in use. When the user turns on the switch member 42, the power of the battery 44 is transmitted to the illuminating member 30 through the electric wires 50 for the illuminating member 30 to illuminate. Because the illuminating member 30 is disposed at the end of the torque indicator 20 opposite to the window 131, the light from the illuminating member 30 first passes through the indication portion 22 and then the window 131 to provide illumination for the indication portion 22. When the present invention is used under an inadequate lighting environment, through the window 131, the user can watch the indication portion 22 clearly to know the present setting torque value of the torque wrench main body 10, without using a flashlight. The present invention enhances the convenience of operation greatly.

It is noted that the rest of the torque indicator 20, except the indication portion 22 is the opaque portion 23, so only the indication portion 22 of the transparent body 21 is pervious to light. When the illuminating member 30 illuminates, the light from the illuminating member 30 will be blocked by the opaque portion 23 and pass through the transparent body 21 only from the position of the indication portion 22. This design can block the interference of diffused light for the user to watch the indication portion 22 easily.

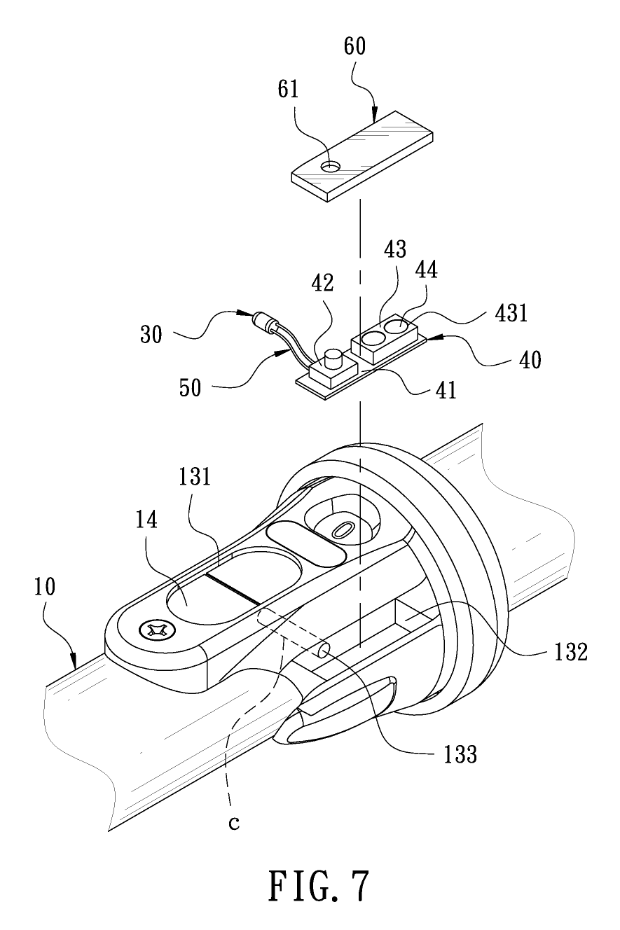

FIG. 7 is a partial exploded view according to a second embodiment of the present invention. The second embodiment is substantially similar to the first embodiment with the exceptions described hereinafter. The switch member 42 is a press switch instead of the DIP switch, namely, the configuration of the switch member 42 is not limited to the first embodiment. Thereby, when the present invention is used under an inadequate lighting environment, through the window 131, the user can watch the indication portion 22 clearly like the first embodiment.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A torque wrench having a transparent window illumination structure, comprising:
a torque wrench main body having at least one window on an outer surface thereon;
a torque indicator corresponding in position to the window, the torque indicator having an indication portion which is pervious to light, the indication portion being adapted to show a present setting torque value of the torque wrench main body;
at least one illuminating member disposed at an end of the torque indicator opposite to the window, light from the illuminating member first passing through the indication portion and then the window; and
a control unit disposed on the torque wrench main body and electrically connected with the illuminating member, the control unit having a switch member adapted to turn on/off the illuminating member and at least one battery for supplying power.

2. The torque wrench having a transparent window illumination structure as claimed in claim 1, wherein the torque wrench main body has an inner rod, an outer rod, and a handle, the inner rod having a groove on an outer surface thereof, the outer rod being fitted at an outer end of the inner rod, the outer rod having an opening corresponding to the groove, the handle being fitted at an outer end of the outer rod, the handle having the window corresponding to the opening, the torque indicator and the illuminating member being disposed in the groove.

3. The torque wrench having a transparent window illumination structure as claimed in claim 2, wherein the handle has an accommodation trough, the control unit being disposed in the accommodation trough.

4. The torque wrench having a transparent window illumination structure as claimed in claim 3, wherein the inner rod has a first through hole communicating with the groove, the outer rod having a second through hole corresponding to the first through hole, the handle having a third through hole corresponding to the second through hole, the third through hole communicating with the accommodation trough, the first through hole, the second through hole and the third through hole constituting a passage communicating with the groove and the accommodation through, a plurality of electric wires being provided in the passage and connected between the illuminating member and the control unit for electrically connecting the illuminating member and the control unit.

5. The torque wrench having a transparent window illumination structure as claimed in claim 3, further comprising an outer lid, the outer lid being adapted to cover the accommodation trough and having a through hole corresponding to the switch member.

6. The torque wrench having a transparent window illumination structure as claimed in claim 1, wherein the torque indicator has a transparent body, the transparent body having an indication portion, the rest of the transparent body, except the indication portion, being an opaque portion, only the indication portion of the transparent body being pervious to light.

7. The torque wrench having a transparent window illumination structure as claimed in claim 6, wherein the indication portion is a scale mark.

8. The torque wrench having a transparent window illumination structure as claimed in claim 1, wherein the control unit further comprises a circuit board, the switch member and the battery being disposed on the circuit board and electrically connected through the circuit board.

9. The torque wrench having a transparent window illumination structure as claimed in claim 8, wherein the control unit further comprises a battery case, the battery case being disposed on the circuit board, the battery case having at least one battery trough, the battery being disposed in the battery trough.

10. The torque wrench having a transparent window illumination structure as claimed in claim 1, wherein the window is covered with a transparent positioning plate.
